(19) United States
(12) Patent Application Publication
(10) Pub. No.: US 2012/0059889 A1
(43) Pub. Date: Mar. 8, 2012

(54) MAIL SERVER APPARATUS AND ELECTRONIC MAIL PROCESSING METHOD

(75) Inventor: Yoshiaki UCHIDA, Kawasaki (JP)

(73) Assignee: FUJITSU LIMITED, Kawasaki-shi (JP)

(21) Appl. No.: 13/225,659

(22) Filed: Sep. 6, 2011

(30) Foreign Application Priority Data
Sep. 6, 2010 (JP) 2010-199246

(51) Int. Cl. G06F 15/16

(52) U.S. Cl. 709/206

(57) ABSTRACT

A mail server apparatus includes, a receiving unit configured to receive a plurality of e-mails addressed to a user, a determination unit configured to determine a priority of each of the e-mails received by the receiving unit and a processing unit configured to select a predetermined number of e-mails from the plurality of e-mails received by the receiving unit, on the basis of priority determined by the determination unit, and treat e-mails as if the e-mails had not arrived, except for the selected predetermined number of e-mails, upon receipt of a request from a user device.

### CROSS-REFERENCE TO RELATED APPLICATIONS

This application is based upon and claims the benefit of priority of the prior Japanese Patent Application No. 2010-199246, filed on Sep. 6, 2010, the entire contents of which are incorporated herein by reference.

### FIELD

The present invention relates to a technique for preventing a mail server from becoming congested.

### BACKGROUND

Currently, electronic mail is widely used not only for private purposes but also for business purposes in business enterprises and the like. By using a mailer installed in a user device such as a personal computer (hereinafter referred to as a “PC”) or a mobile device, each user accesses a mail server and receives electronic mail addressed to the user.

The mail server includes a sending server and a receiving server. The sending server and the receiving server are sometimes implemented as separate servers. The sending server transfers, to another mail server, electronic mail sent from a user having a registered e-mail account. The sending server is called an SMTP (Simple Mail Transfer Protocol) server or the like. Herein, a user having an e-mail account registered to a mail server is referred to as a “registered user”. The receiving server receives electronic mail messages (i.e., e-mail(s)) addressed to a registered user, and, in response to a transfer request from the user, transfers the received electronic mail to the user's device. The examples of receiving servers are called a POP (Post Office Protocol) 3 server, an IMAP (Internet Message Access Protocol) server, or the like.

In such a mail server, the processing load increases in accordance with, for example, the number of registered users and the number of e-mails to be processed. On the other hand, the number of e-mails to be processed in the mail server, including unnecessary e-mails Unsolicited Commercial Email (so called spam e-mails), tends to increase. When the processing load of the mail server exceeds its processing capability, the mail server becomes congested, and the response time of the mail server slows down. This sometimes imposes a burden on e-mail services and operations.

To solve such a problem, in may case they replace mail servers by new one having high processing capabilities in terms of operation for distributing the processing load of a mail server are employed.

### SUMMARY

According to an aspect of the invention, a mail server apparatus includes, a receiving unit configured to receive a plurality of e-mails addressed to a user, a determination unit configured to determine a priority of each of the e-mails received by the receiving unit and a processing unit configured to select a predetermined number of e-mails from the plurality of e-mails received by the receiving unit, on the basis of priority determined by the determination unit, and treat e-mails as if these e-mails had not arrived, except for the selected predetermined number of e-mails, upon receipt of a request from a user device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a conceptual view illustrating an exemplary structure of a mail system to which a mail server apparatus of the disclosed embodiments is applied.

FIG. 2 illustrates an exemplary processing configuration of a mail server apparatus in a first embodiment.

FIG. 3 is a conceptual view of a mail storing unit in the first embodiment.

FIG. 4 illustrates an exemplary user-specified information storing unit.

FIG. 5A is a flowchart illustrating an electronic mail receiving process of the mail server apparatus in the first embodiment.

FIG. 5B is a flowchart illustrating the electronic mail receiving process of the mail server apparatus in the first embodiment.

FIG. 6 is a flowchart illustrating a POP message response process of the mail server apparatus in the first embodiment.

FIG. 7 illustrates an exemplary processing configuration of a mail server apparatus in a second embodiment.

FIG. 8 is a conceptual view of a mail storing unit in the second embodiment.

FIG. 9 is a flowchart illustrating a POP message response process of the mail server apparatus in the second embodiment.

FIG. 10 illustrates an exemplary processing configuration of a mail server apparatus in a third embodiment.

FIG. 11 is a flowchart illustrating a process of determining a predetermined number N in the third embodiment.

### DESCRIPTION OF EMBODIMENTS

(System Configuration)

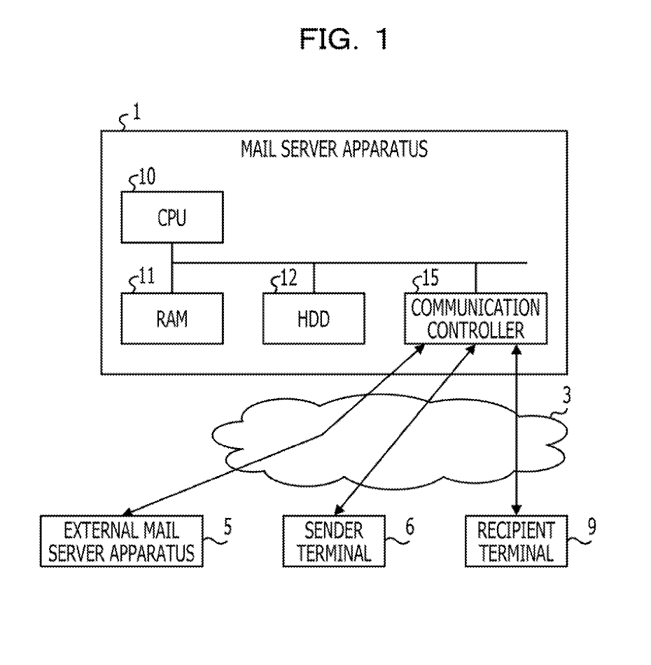

FIG. 1 is a conceptual view illustrating an exemplary structure of a mail system to which a mail server apparatus of the disclosed embodiments is applied. As illustrated in FIG. 1, a mail server apparatus 1 is communicatively connected through a network 3 with an external mail server apparatus 5, a sender device 6, a recipient device 9, and the like.

The sender device 6 and the recipient device 9 are user devices that registered users of the mail server apparatus 1, that is, users of the internal domain of the mail server apparatus 1 use. Such user devices are information processing devices having functions of sending and receiving e-mails, such as PCs, cellular phones, and portable devices. A user starts up a mailer installed in a user device, and then accesses the mail server apparatus 1 and reads e-mails addressed to the user, sends e-mails to another user, or the like. Herein, as illustrated in FIG. 1, for the sake of convenience of description, the sender device 6 as a user device for sending e-mails and the recipient device 9 as a user device for receiving e-mails will be separately described. It is to be noted that FIG. 1 is not intended to limit the forms of the sender device 6 and the recipient device 9, and therefore the sender device 6 and the recipient device 9 only need to be typical electronic mail clients.

The external mail server apparatus 5 is a mail server of a domain different from that of the mail server apparatus 1 (herein referred to as an “external domain”). The external mail server apparatus 5 transfers to the mail server apparatus 1 an e-mail addressed to the domain of the mail server apparatus 1 (herein referred to as an “internal domain”) through a protocol such as SMTP. It is to be noted that FIG. 1 is not intended to limit the form of the external mail server apparatus 5, and therefore the external mail server apparatus 5 may be a typical mail server, and may also be a mail server similar to the mail server apparatus 1 of FIG. 1.

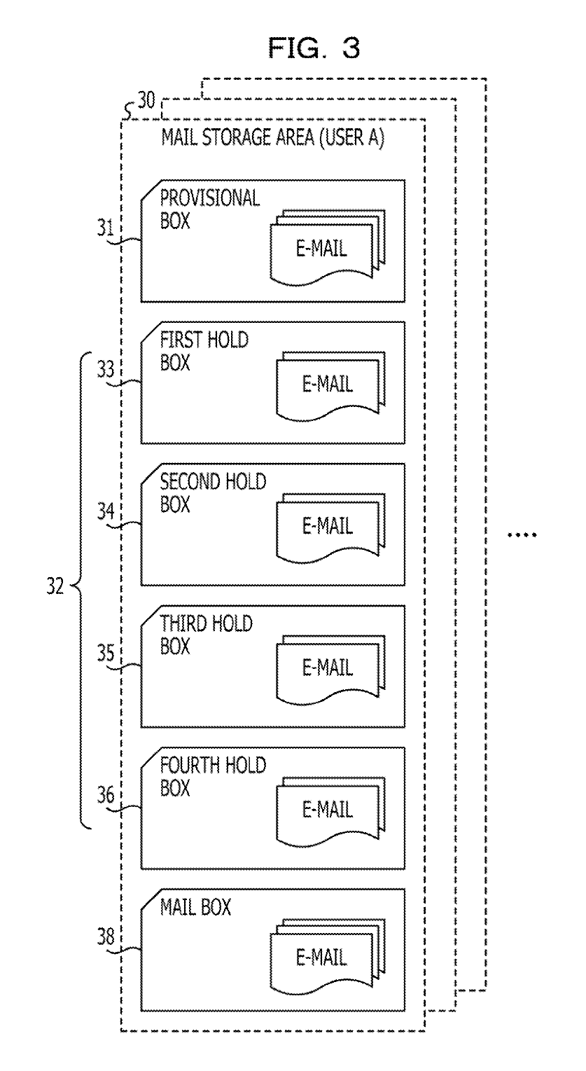

The network 3 is a public network such as the Internet, a WAN (Wide Area Network), a LAN (Local Area Network), a radio communication network, or the like. FIG. 3 is not intended to limit the form of the network 3. The network 3 only needs to be a network that allows execution of an e-mail communication protocol such as POP3, IMAP, or SMTP.

(Hardware Configuration of Mail Server Apparatus)

The mail server apparatus 1 disclosed in FIG. 1 has a typical hardware configuration of an information processing device. That is, the mail server apparatus 1 includes, as the hardware configuration, a microprocessor such as a CPU (Central Processing Unit) 10, storage units such as a RAM (Random Access Memory) 11 and an HDD (Hard Disk Drive) 12, a communication controller 15, and the like. The communication controller 15 is connected to the network 3 to implement a protocol for sending and receiving e-mails to and from the external mail server apparatus 5, the sender device 6, the recipient device 9, and the like.

In the mail server apparatus 1, a program stored in a storing device (recording medium) such as the HDD 12 is executed by a microprocessor (computer) such as the CPU 10, thereby, while cooperating with hardware as described above, implementing processing units as will be described below. It is to be noted that, in the below embodiments, only processing units related to e-mails will be presented; however, other processing units may be implemented. It is also to be noted that the recording medium as used herein may include recording media having portability, such as USB (Universal Serial Bus) memories, and disc recording media from which data is read and to which data is written via a drive device, such as CDs (compact discs) and DVDs (digital versatile discs).

### First Embodiment

A mail server apparatus in a first embodiment will be described below.

(Processing Configuration)

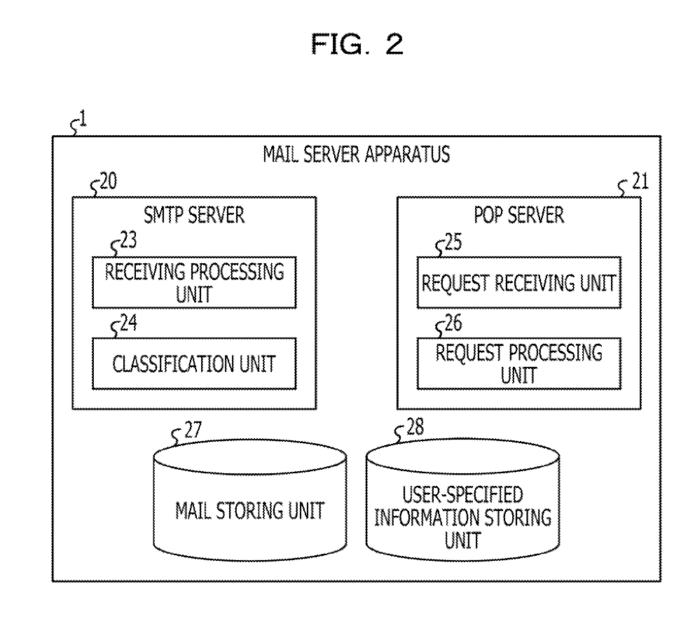

FIG. 2 illustrates an exemplary processing configuration of the mail server apparatus in the first embodiment.

As illustrated in FIG. 2, the mail server apparatus 1 in the first embodiment includes an SMTP server 20, a POP server 21, a mail storing unit 27, a user-specified information storing unit 28, and the like. In the first embodiment, the SMTP server 20 and the POP server 21 are implemented as software elements such as processes, tasks, and threads.

The mail storing unit 27 stores, on a user-by-user basis, e-mails addressed to users of the internal domain. FIG. 3 is a conceptual view of a mail storing unit in the first embodiment. As illustrated in FIG. 3, the mail storing unit 27 has a mail storage area 30 for each destination user (account) of the internal domain.

Each mail storage area 30 includes a provisional box 31, hold boxes 32, and a mail box 38 as memory areas for storing e-mails. The provisional box 31 is an area where e-mails sent from the sender device 6 and the external mail server apparatus 5 are temporarily stored. The mail box 38 is an area where e-mails that have been stored in the provisional box 31 are finally stored; e-mails stored in the mail box 38 are treated as indeed delivered e-mails that addressed to each user.

The hold boxes 32 are areas for storing e-mails stored in the provisional box 31 prior to moving them as new e-mails into the mail box 38. The hold boxes 32 include a first hold box 33, a second hold box 34, a third hold box 35, and a fourth hold box 36 that correspond to priorities of e-mails. The first hold box 33 stores e-mails of a first priority, the second hold box 34 stores e-mails of a second priority, the third hold box 35 stores e-mails of a third priority, and the fourth hold box 36 stores e-mails of a fourth priority. It is assumed herein that the first priority indicates the highest priority, and the fourth priority indicates the lowest priority. Thus, e-mails that have been stored in the provisional box 31 are held in the hold boxes 32 depending on the priorities of the e-mails, and then are finally moved as new e-mails into the mail box 38.

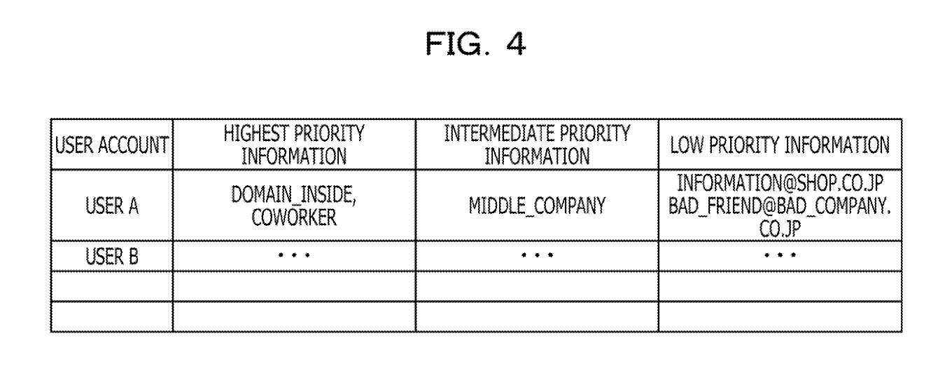

In the user-specified information storing unit 28, information specified by each user for determining the priorities of e-mails as described above is stored. FIG. 4 illustrates an exemplary user-specified information storing unit. In the user-specified information storing unit 28, a user account, the highest priority information, intermediate priority information, and low priority information are stored for each user. The user account includes information identifying each user.

In the highest priority information, the intermediate priority information, and the low priority information, an e-mail address of a source, or part thereof (such as a user name and a domain), is stored as information for determining the priority of a received e-mail addressed to each user. In the first embodiment, in the case where the e-mail address of a source includes a domain name that is the same as the user (internal domain) and is included in a range specified by the highest priority information, the priority of the e-mail is determined to be the first priority. In the case where the e-mail address of a source includes a domain name that is different from that of the user (external domain) and is included in a range specified by the intermediate priority information, the priority of the e-mail is determined to be the second priority. In the case where the e-mail address of a source includes a domain name that is different from that of the user (external domain) and is included in a range specified by the low priority information, the priority of the e-mail is determined to be the fourth priority.

For example, an e-mail sent from an employee in a company (user name: COWORKER) has a high possibility of being the content of work, and therefore it is preferable that such an e-mail be assigned a high priority for reference. In this case, the user name (COWORKER) is set in a highest priority information field. On the other hand, the degree of urgency of regularly delivered e-mails, such as bargain information of predetermined shops, is not much high. Accordingly, in this case, the e-mail address (information@shop.co.jp) of the source is stored in a low priority information field. That is, source information of an e-mail that is assigned the highest priority for the purpose of reference for each user is stored in the highest priority information field, and source information of an e-mail that may be referred to later is stored in the low priority information field.

The SMTP server 20 receives an e-mail addressed to an external domain from the sender device 6, and transfers the e-mail to the external mail server apparatus 5 corresponding to the external domain, using a protocol such as SMTP. Also the SMTP server 20, which includes the receiving processing unit 23, the classification unit 24, and the like, receives, using a protocol such as SMTP, e-mails addressed to the internal domain and sent from the external mail server apparatus 5, the sender device 6, and the like. It is to be noted that the receiving protocol for e-mails addressed to the internal domain and the transfer protocol for e-mails addressed to the external domain is not limited to SMTP.

Having received an e-mail addressed to the internal domain, the receiving processing unit 23 stores the e-mail in the provisional box 31 of the mail storage area 30 of a user indicated by destination information (a To field, a Cc field, and a Bee field) included in header information of the e-mail. Upon completion of receiving the e-mail and storing the e-mail in the provisional box 3, the receiving processing unit 23 activates the classification unit 24.

The classification unit 24 determines the priorities of e-mails stored in the provisional box 31, and moves the e-mails in the provisional box 31 into the hold boxes 32 depending upon the priorities. The classification unit 24 acquires sender information (a From field and a Sender field) included in header information of an e-mail, and determines the priorities of the e-mails according to the sender information.

Specifically, in the case where sender information of an e-mail indicates a user of the internal domain and is included in the range of the highest priority information of the user-specified information storing unit 28 regarding the destination user of the e-mail, the classification unit 24 determines that the priority of the e-mail is the first priority. In the case where sender information indicates a user of the internal domain, and in the case where sender information indicates a user of the external domain and is included in the range of the intermediate priority information of the user-specified information storing unit 28 regarding the destination user of an e-mail, the classification unit 24 determines that the priority of the e-mail is the second priority. Alternatively, in the case where sender information indicates a user of the external domain and is included in the range of the low priority information of the user-specified information storing unit 28 regarding the destination user of an e-mail, the classification unit 24 determines that the priority of the e-mail is the fourth priority. In the case where sender information is not included in any of the first priority, the second priority, and the fourth priority, the classification unit 24 determines that the priority of an e-mail is the third priority.

Upon determining the priorities of e-mails in this way, the classification unit 24 moves the e-mail determined to be the first priority into the first hold box 33, moves the e-mail determined to be the second priority into the second hold box 34, moves the e-mail determined to be the third priority into the third hold box 35, and moves the e-mail determined to be the fourth priority into the fourth hold box 36. It is to be noted that the classification unit 24 may regularly perform such a moving process of e-mails in the provisional box 31.

In response to a request from the recipient device 9, the POP server 21 provides to the recipient device 9 a response regarding e-mails stored in the mail box 38 of a user of the recipient device 9 using a protocol such as POP3 or IMAP. It is to be noted that the protocol between the POP server 21 and the recipient device 9 is not limited to POP3 and IMAP.

The POP server 21 includes a request receiving unit 25, a request processing unit 26, and the like.

Upon receipt of an access from the recipient device 9, the request receiving unit 25 moves a predetermined number, N, of e-mails for the user from the hold boxes 32 into the mail box 38. For example, at the start-up of a moving process for e-mails, the request receiving unit 25 authenticates the user. Specifically, the request receiving unit 25 receives a USER command and a PASS command from the recipient device 9, verifies a user account and a password included in these commands against registered normal data, and starts the moving process for e-mails if the verification is successfully accomplished.

The request receiving unit 25 acquires the predetermined number N for the accessing user. The predetermined number N is determined in advance for each user and may be stored in a memory or the like, and may be a fixed value that is the same for all users.

Having obtained the predetermined number N, the request receiving unit 25 confirms the presence of e-mails stored in the hold boxes 32 in the mail storage area 30, and moves N e-mails in order of descending priority (in the order of the first hold box 33, the second hold box 34, the third hold box 35, and the fourth hold box 36) from the hold boxes 32 into the mail box 38. Upon completion of the moving process for the e-mails, the request receiving unit 25 causes the request processing unit 26 to respond to the access for the mail checking from the recipient device 9.

The request processing unit 26 makes a response regarding e-mails stored in the mail box 38 to a request sent from the recipient device 9 after the user has been authenticated. For example, with POP3, having received a STAT command from the recipient device 9, the request processing unit 26 sends a response message including the number of e-mails stored in the mail box 38 of the user and the total data size of the e-mails. The request processing unit 26 performs processing of e-mails stored in the mail box 38 in response to, for example, a LIST command for acquiring a mail list, an RETR command for reading a specified e-mail, and a DELE command for deleting a specified e-mail, in POP3 or the like.

The request processing unit 26 may add not only information on e-mails in the mail box 38 but also information on e-mails receiving a lower priority and held in the hold boxes 32 to a standardized response message in POP3, IMAP, or the like. For example, as a response to the STAT command, the number of e-mails in the hold boxes 32 is added to “+OK (the number of e-mails in the mail box 38) (the total data size of e-mails in the mail box 38)”. Providing new information as additional information in this way enables such a response message to be normally processed in cases where a mailer does not support new information.

(Operation Example in First Embodiment)

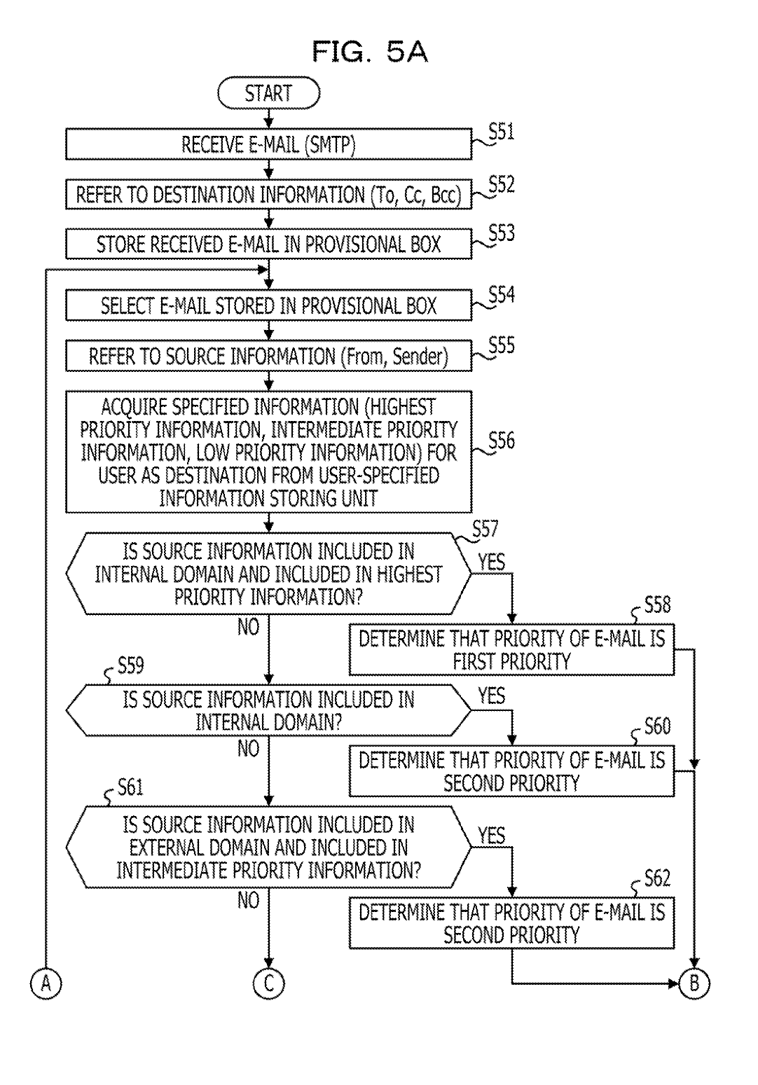

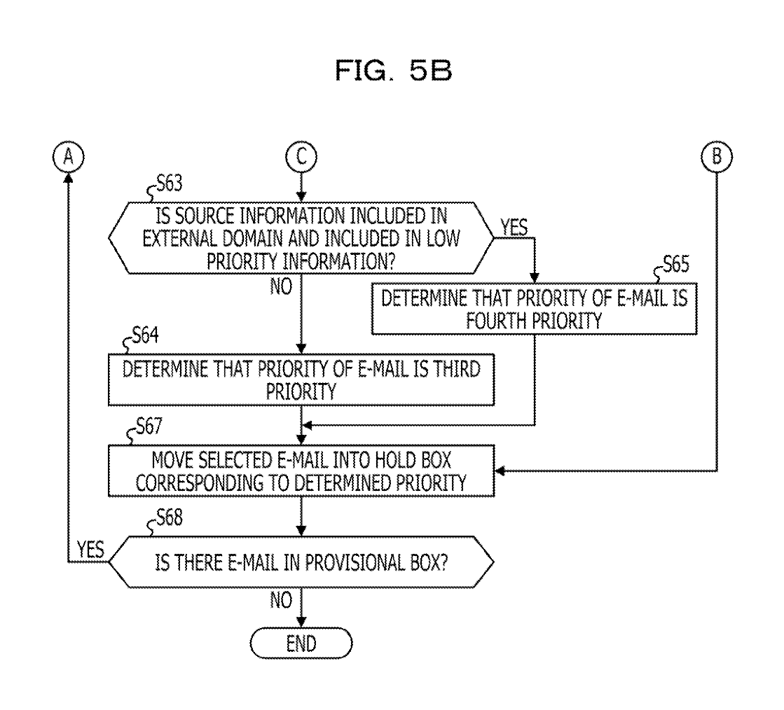

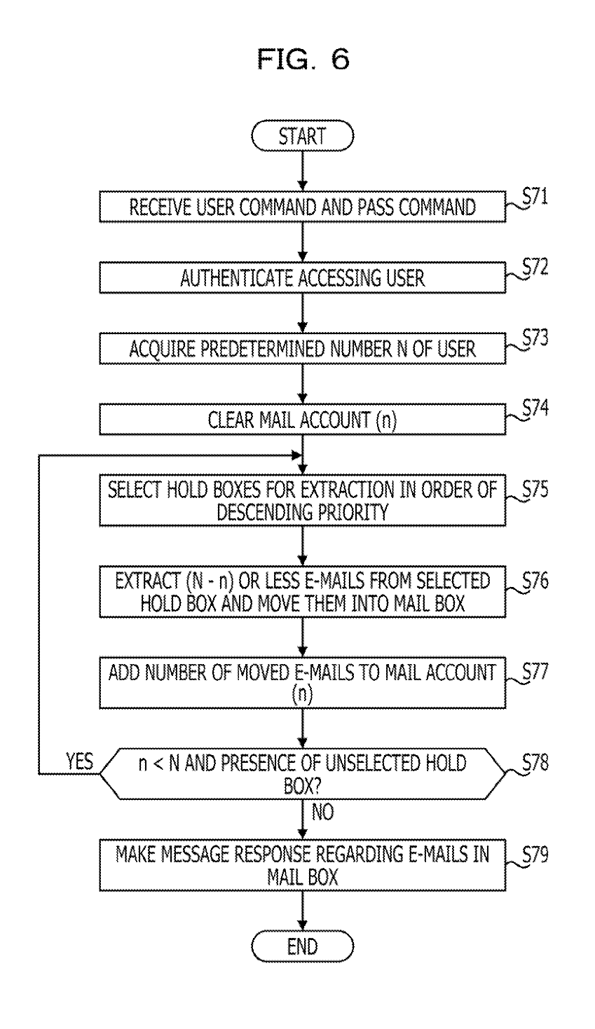

An operation example of the mail server apparatus 1 in the first embodiment will be described below with reference to FIGS. 5A and 5B and FIG. 6. FIGS. 5A and 5B are flowcharts illustrating an electronic mail receiving process of the mail server apparatus 1 in the first embodiment.

When an e-mail addressed to the internal domain has been sent from the external mail server apparatus 5, the sender device 6, or the like, in the mail server apparatus 1, the receiving processing unit 23 of the SMTP server 20 receives the e-mail (S51). The receiving processing unit 23 refers to destination information (the To field, the Cc field, the Bee field, and the like) included in header information of the received e-mail (S52). The receiving processing unit 23 stores the e-mail in the provisional box 31 of the mail storage area 30 of a user indicated by the destination information (S53).

Subsequently, the classification unit 24 selects an e-mail stored in the provisional box 31 (S54). The classification unit 24 refers to source information (the From field, the Sender field, and the like) included in header information of the selected e-mail (S55). The classification unit 24 extracts the highest priority information, intermediate priority information, and low priority information for a user as the destination from the user-specified information storing unit 28 (S56).

The classification unit 24 determines, on the basis of the source information and information specified by the user, the priority of the selected e-mail as follows. The classification unit 24 determines whether the source information is included in the internal domain and is included in the highest priority information (S57). If the classification unit 24 determines that the source information is included in the internal domain and included in the highest priority information (S57; YES), then the classification unit 24 makes a determination that the priority of the selected e-mail is the first priority (S58). If the classification unit 24 determines that the source information is not included in both the internal domain and the highest priority information (S57; NO), then the classification unit 24 further determines whether the source information is included in the internal domain (S59). If the classification unit 24 determines that the source information is included in the internal domain and is not included in the highest priority information (S59; YES), then the classification unit 24 makes a determination that the priority of the selected e-mail is the second priority (S60).

If the classification unit 24 determines that the source information is not included in the internal domain (S59; NO), then the classification unit 24 further determines whether the source information is included in the external domain and is included in the intermediate priority information (S61). If the classification unit 24 determines that the source information is included in the external domain and is included in the intermediate priority information (S61; YES), then the classification unit 24 makes a determination that the priority of the selected e-mail is the second priority (S62). If the classification unit 24 determines that the source information is included in the external domain and is not included in the intermediate priority information (S61; NO), then the classification unit 24 further determines whether the source information is included in the external domain and is included in the low priority information (S63).

If the classification unit 24 determines that the source information is included in the external domain and is included in the low priority information (S63; YES), then the classification unit 24 makes a determination that the priority of the selected e-mail is the fourth priority (S65). On the other hand, if the classification unit 24 determines that the source information is included in the external domain and is not included in the low priority information (S63; NO), then the classification unit 24 makes a determination that the priority of the selected e-mail is the third priority (S64).

Upon making a determination of the priority of the selected e-mail in this way, the classification unit 24 moves the e-mail from the provisional box 31 into the hold box 32 corresponding to the determined priority (S67). Specifically, in the case where it is determined that the priority of an e-mail is the first priority, the e-mail is moved into the first hold box 33. In the case where it is determined that the priority of an e-mail is the second priority, the e-mail is moved into the second hold box 34. In the case where it is determined that the priority of an e-mail is the third priority, the e-mail is moved into the third hold box 35. In the case where it is determined that the priority of an e-mail is the fourth priority, the e-mail is moved into the fourth hold box 36.

The classification unit 24 continues such a moving process of e-mails from the provisional box 31 into the hold boxes 32 until no e-mail remains in the provisional box 31 (S68). For the provisional boxes 31 of other users, processes similar to the moving process are performed.

FIG. 6 is a flowchart illustrating a POP message response process of the mail server apparatus 1 in the first embodiment. It is to be noted that an operation example in the case of using POP3 is presented in an example of FIG. 6; however, in the case of using another protocol such as IMAP, only the content of message text to be used is different, and the same operation as in the example of FIG. 6 is basically performed.

In the recipient device 9, processing in POP3 is started toward the mail server apparatus 1 when a user checks e-mails by operating a mailer. That is, the recipient device 9 accesses a port of the POP server 21 of the mail server apparatus 1. Upon an access from the recipient device 9 to the port of POP3, in the mail server apparatus 1, the request receiving unit 25 of the POP server 21 responds to the access. In an example of a command sequence of POP3, the request receiving unit 25 receives a USER command from the recipient device 9. Then, in response to this receipt, sending a response message to the effect of requesting a password, the request receiving unit 25 receives a PASS command. In this way, the request receiving unit 25 receives the USER command and the PASS command from the recipient device 9 (S71).

The request receiving unit 25 verifies a user account included in the USER command and a password included in the PASS command using normal data registered in advance, thereby authenticating the accessing user (S72). Having confirmed that the accessing user is a normal user, the request receiving unit 25 acquires the predetermined number N for the user (S73).

Subsequently, the request receiving unit 25 initializes (clears) a mail account (n) (S74). The request receiving unit 25 selects the first hold box 33 of the highest priority from the hold boxes 32 for the accessing user (S75). The request receiving unit 25 moves (N−n) or less e-mails stored in the selected first hold box 33 to the mail box 38 of the accessing user (S76). In this case, the mail account (n) is zero, and therefore e-mails the number of which is equal to or less than the predetermined number N are moved. The request receiving unit 25 adds the number of moved e-mails to the mail account (n) (S77).

The request receiving unit 25 confirms whether the mail account (n) is less than the predetermined number N (S78). If the mail account (n) is less than the predetermined number N (S78; YES), then the request receiving unit 25 selects the second hold box 34 whose priority is second highest (S75), and performs the same e-mail moving processing as described above (S76, S77, and S78). The request receiving unit 25 adds the number of e-mails moved from the second hold box 34 into the mail box 38 to the mail account (n) (S77), and confirms again whether the mail account (n) is less than the predetermined number N (S78). In this way, the request receiving unit 25 selects the third hold box 35 and further selects the fourth hold box 36 until the number of e-mails moved from the hold boxes 32 into the mail box 38 reaches the predetermined number N.

If the mail account (n) reaches the predetermined number N, or the request receiving unit 25 has completed selection of all the hold boxes 32 (S78; NO), then the request receiving unit 25 causes the request processing unit 26 to respond to the access for the mail checking from the recipient device 9. At this point, in the case where there exist e-mails remaining in the hold boxes 32, the request receiving unit 25 may pass the total number of the remaining e-mails to the request processing unit 26.

The request processing unit 26 makes a response regarding e-mails in the mail box 38 of the accessing user to each command that has been sent after the user authentication in the POP3 command sequence (S79). That is, regarding e-mails that are stored in the hold boxes 32 although they have been received by the mail server apparatus 1, the request processing unit 26 treats the e-mails as if they had not arrived, and excludes the e-mails from those the number of which and whose size are included in a response to the STAT command. The e-mails in the hold boxes 32 that have been treated as if they had not arrived are moved into the mail box 38 and are treated as new e-mails when an access in POP3 is next started from the recipient device 9, that is, at the time of the next mail checking.

(Actions and Effects of First Embodiment)

As described above, in the mail server apparatus 1 in the first embodiment, in cases where e-mails addressed to the internal domain are received in the mail transfer protocol, the priorities of the e-mails are determined on the basis of the source information, and the e-mails are stored in the hold boxes 32 in accordance with their priorities. On the other hand, in cases where a mail receiving request is sent from the recipient device 9, e-mails that are selected from the hold boxes in order of descending priority and the number of which is equal to or less than the predetermined number N are moved from the hold boxes 32 into the mail box 38. Thereafter, in response to a request from the recipient device 9, the e-mails in the mail box 38 of the user are treated as incoming e-mails.

According to such an embodiment, in cases where there exist a plurality of e-mails that have been sent to the same user and have arrived at the mail server apparatus 1, and where the number of the e-mails is larger than the predetermined number N, e-mails that are lower in priority, among the plurality of e-mails, are treated as if they had not arrived. Therefore, if the predetermined number N is set to a value in accordance with the processing capability of the mail server apparatus 1, this may suppress a temporary abrupt increase in processing load of the mail server apparatus 1 even in cases where there are a large number of new e-mails. This is because even when each user checks e-mails at one time, the number of e-mails treated as new e-mails for each user is limited to the predetermined number N. As a result, according to the first embodiment, the mail server apparatus 1 may be prevented from becoming congested.

### Second Embodiment

A mail server apparatus in a second embodiment will be described below.

(Processing Configuration)

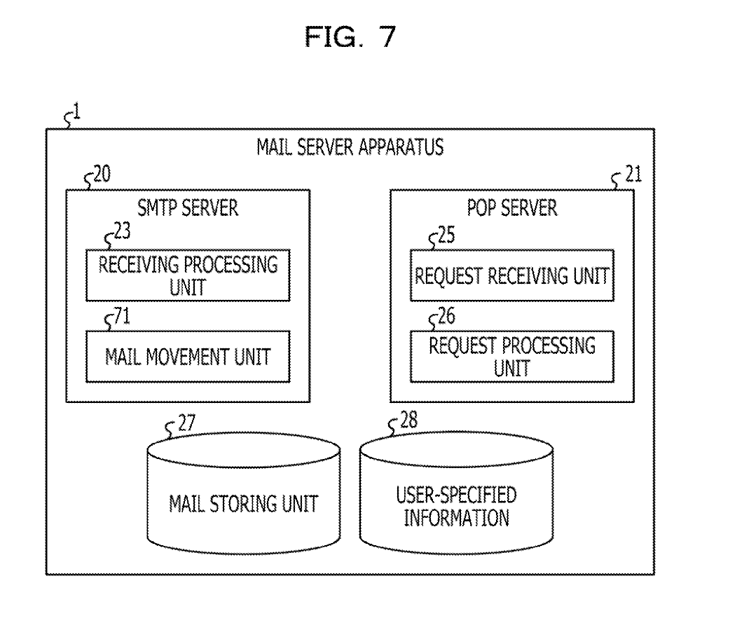

FIG. 7 illustrates an exemplary processing configuration of the mail server apparatus in the second embodiment. The mail server apparatus 1 in the second embodiment has the same configuration as the first embodiment, except that the classification unit 24 in the first embodiment is replaced with a mail movement unit 71. Processing of each unit, however, is partially different from that in the first embodiment. Hereinbelow contents different from those in the first embodiment will be mainly described.

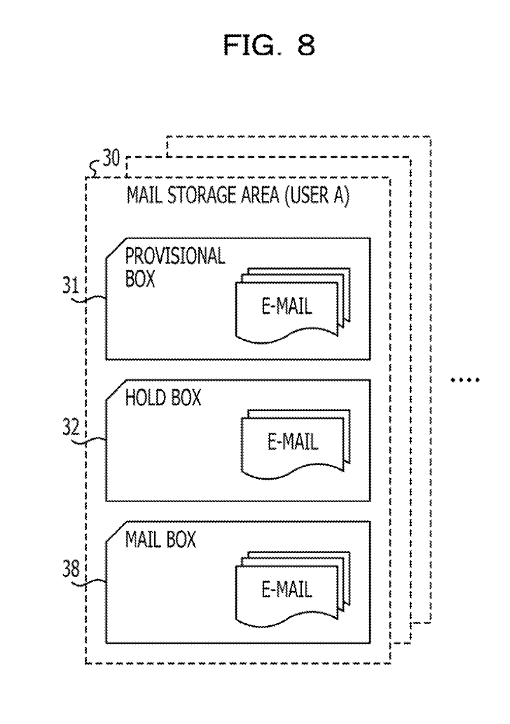

FIG. 8 is a conceptual view of a mail storing unit in the second embodiment. As illustrated in FIG. 8, in the mail storing unit 27 in the second embodiment, the hold box 32 is not divided in accordance with priorities. In the mail storage area 30 for each user, the provisional box 31, the hold box 32, and the mail box 38 are included.

The mail movement unit 71 of the SMTP server 20 is activated upon completion of receiving e-mails and storing them into the provisional box 31 by the receiving processing unit 23. The mail movement unit 71 moves the e-mails in the provisional box 31 into the hold box 32 for each user for which e-mails are present in the provisional box 31. Therefore, in the second embodiment, the SMTP server 20 does not determine priorities of e-mails.

When moving the predetermined number, N, of e-mails from the hold box 32 into the mail box 38, the request receiving unit 25 in the second embodiment determines priorities of e-mails in the hold box 32 and makes a determination of e-mails to be moved in order of descending priority. A method of determining priorities of e-mails is similar to that of the classification unit 24 in the first embodiment. That is, the request receiving unit 25 in the second embodiment refers to user-specified information of the user-specified information storing unit 28.

The request processing unit 26 in the second embodiment adds, in addition to the processing in the first embodiment, not only the number of e-mails and the total data size in the mail box 38 but also the number of e-mails held in the hold box 32 to the response message in response to a PASS command. For example, the request processing unit 26 provides a response of text saying “OK (user name) has (the number of e-mails in the mail box 38) messages ((total data size of e-mails in the mail box 38)) (the number of e-mails in the hold box 32) deferred.”

In the case where the number of e-mails in the hold box 32 is larger than a preset value XN set for each user, the request processing unit 26 may add text saying “Note! (the number of e-mails in the hold box 32) deferred.” in order to attract attention.

(Operation Example in Second Embodiment)

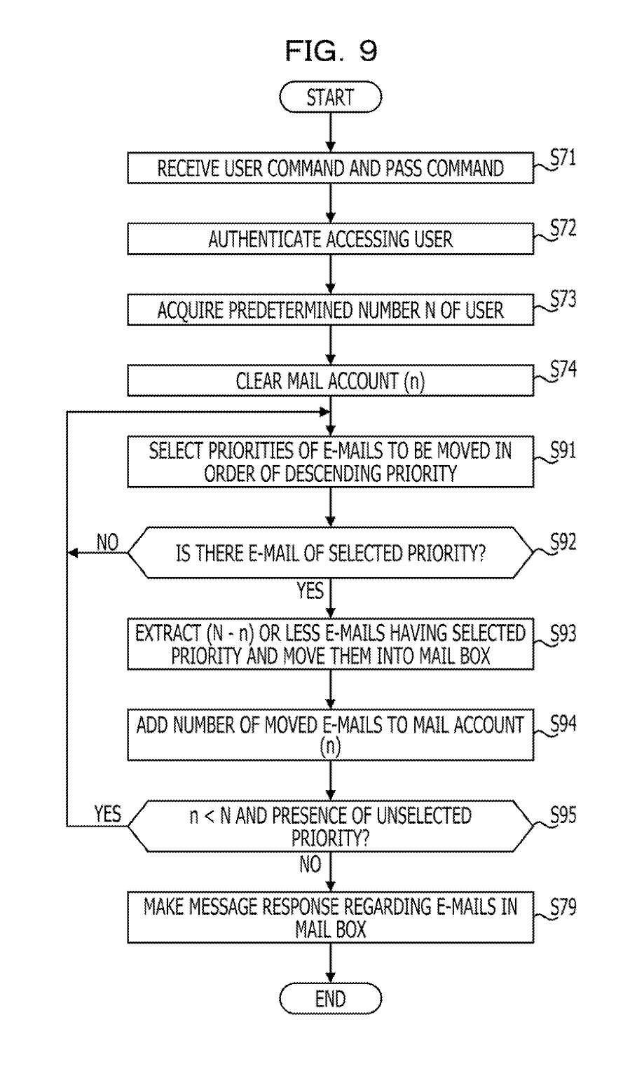

An operation example of the mail server apparatus 1 in the second embodiment will be described below with reference to FIG. 9. FIG. 9 is a flowchart illustrating a POP message response process of the mail server apparatus 1 in the second embodiment. It is to be noted that the operation example in the case of using POP3 is illustrated in an example of FIG. 9; however, even in the case of using another protocol such as IMAP, only the content of message text to be used is different, and the same operation as in the example of FIG. 9 is basically performed.

In the mail server apparatus 1 in the second embodiment, the same processing as in the first embodiment is performed until the mail account (n) is cleared (S71, S72, S73, and S74).

The request receiving unit 25 selects priorities of e-mails to be moved in order of descending priority. First, the request receiving unit 25 selects the first priority that is the highest (S91). The request receiving unit 25 confirms the presence of e-mails of the first priority among e-mails in the hold box 32 for the accessing user (S92). If the request receiving unit 25 determines that there is an e-mail of the first priority (S92; YES), then (N−n) or less e-mails having the first priority are moved from the hold box 32 into the mail box 38 (S93). In this case, the mail account (n) is zero, and therefore e-mails the number of which is equal to or less than the predetermined number N are moved. The request receiving unit 25 adds the number of moved e-mails to the mail account (n) (S94).

The request receiving unit 25 confirms whether the mail account (n) is less than the predetermined number N (S95). If the mail account (n) is less than the predetermined number N (S95; YES), then the request receiving unit 25 selects the second priority that is the second highest priority (S91), and performs the same e-mail moving processing as described above (S92, S93, and S94). The request receiving unit 25 adds the number of e-mails of the second priority moved from the hold box 32 into the mail box 38 to the mail account (n) (S94), and confirms again whether the mail account (n) is less than the predetermined number N (S95). In this way, the request receiving unit 25 selects the third priority and further selects the fourth priority until the number of e-mails moved from the hold box 32 into the mail box 38 reaches the predetermined number N.

If the mail account (n) reaches the predetermined number N, or the request receiving unit 25 has completed selection of all the priorities (S95; NO), then the request receiving unit 25 causes the request processing unit 26 to respond to the access for the mail checking from the recipient device 9. At this point, in the case where there exist e-mails remaining in the hold boxes 32, the request receiving unit 25 may pass the total number of the remaining e-mails to the request processing unit 26.

The request processing unit 26 generates a message including the number of e-mails in the mail box 38 and their total data size, and the number of e-mails held in the hold box 32 as a response message in response to a PASS command, and sends the response to the recipient device 9 (S79). For each command sent after the PASS command, the request processing unit 26 provides a response regarding e-mails in the mail box 38 of the accessing user.

It is to be noted that the determination of the priority of each e-mail in the above-described operation example may be performed sequentially from one e-mail to another along the moving processing of e-mails, and may be performed for all e-mails in the hold box 32 before the moving processing of e-mails.

(Actions and Effects of Second Embodiment)

As described above, in the mail server apparatus 1 in the second embodiment, in cases where an e-mail addressed to the internal domain is received in the mail transfer protocol, the e-mail is stored in the hold box 32. On the other hand, in cases where a mail receiving request is sent from the recipient device 9, e-mails the number of which is equal to or less than the predetermined number N, among e-mails held in the hold box 32 of the accessing user are moved from the hold box 32 into the mail box 38 in order of descending priority. That is, in the second embodiment, unlike the first embodiment, the POP server 21, not the SMTP server 20, determines the priorities of e-mails.

In such an embodiment as the second embodiment, effects similar to those in the first embodiment may be obtained.

### Third Embodiment

A mail server apparatus in a third embodiment will be described below.

(Processing Configuration)

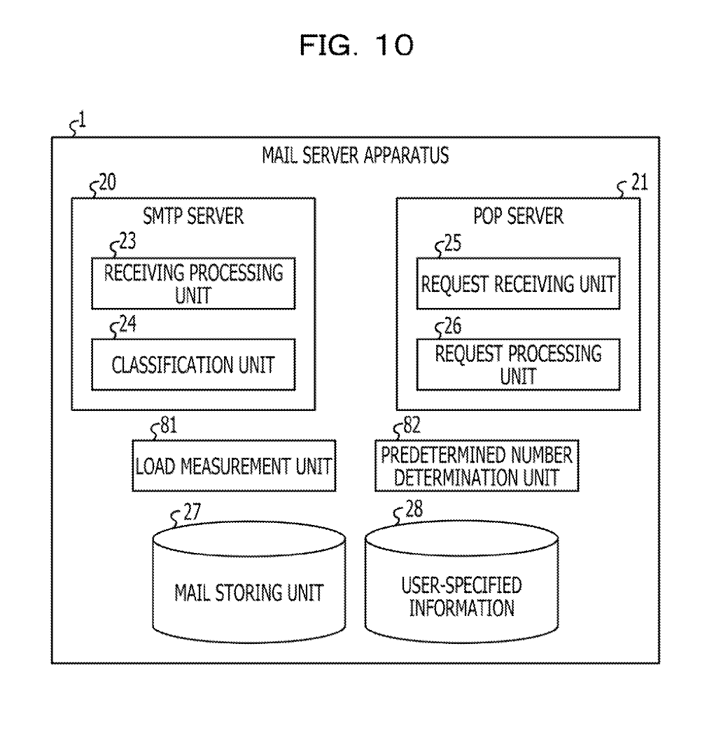

FIG. 10 illustrates an exemplary processing configuration of the mail server apparatus in the third embodiment. The mail server apparatus 1 in the third embodiment includes, in addition to the configuration of the first embodiment, a load measurement unit 81 and a predetermined number determination unit 82. It is to be noted that an example based on the configuration of the first embodiment is illustrated in FIG. 10; however, the mail server apparatus 1 may include, in addition to the configuration of the second embodiment, the load measurement unit 81 and the predetermined number determination unit 82. Hereinbelow contents different from those in the first and second embodiments will be mainly described.

The load measurement unit 81 measures the processing load of the mail server apparatus 1. For example, the load measurement unit 81 measures the load of the CPU 10 and the time for a response to the recipient device 9 to measure the processing load in question. The load measurement unit 81 may estimate the processing load in accordance with the number of e-mails stored in the hold box 32 and the number of the accessing recipient devices 9, and may also determine the processing load by combining the above information. The present embodiment is not intended to limit the method of measuring the processing load of the mail server apparatus 1. The load measurement unit 81 sends information on the acquired processing load to the predetermined number determination unit 82.

In accordance with the information on the processing load sent from the load measurement unit 81, the predetermined number determination unit 82 determines the predetermined number N in question. Specifically, the predetermined number determination unit 82 decreases the predetermined number N in cases where the processing load of the mail server apparatus 1 is high, and increases the predetermined number N in cases where the processing load of the mail server apparatus 1 is low. For a determination of whether the processing load is high or low, a predetermined threshold may be used. The amount of increase or decrease of the predetermined number N may be variable in accordance with the processing load, and may also be constant.

In the case where the predetermined number N (u) is provided for each accessing user (u), the above-mentioned increase and decrease processing may be made for the predetermined number N (u) of each user. Further, users may be classified into those for whom the predetermined number N (u) is increased or decreased and those for whom the predetermined number N (u) is neither increased nor decreased such that the increase and decrease processing is performed only for the former.

The predetermined number N updated in accordance with the processing load of the mail server apparatus 1 in such a way is referred to by the request receiving unit 25. It is to be noted that the operation timings of the load measurement unit 81 and the predetermined number determination unit 82 may be or need not be in conjunction with each other, or may be at predetermined intervals.

(Operation Example in Third Embodiment)

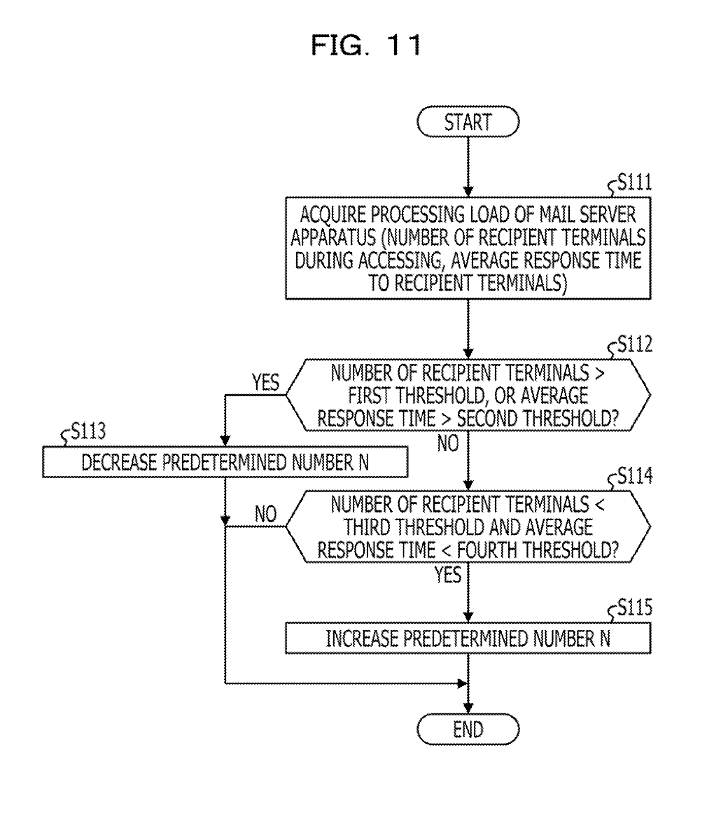

FIG. 11 is a flowchart illustrating a process of determining the predetermined number N in the third embodiment. Illustrated in FIG. 11 is an example in which the number of recipient devices 9 during accessing and the average time for responses to the recipient devices 9 are used as the processing load of the mail server apparatus 1.

The load measurement unit 81 acquires the number of recipient devices 9 during accessing and the average time for responses to the recipient devices 9 at an arbitrary timing (S111). The acquired information is sent to the predetermined number determination unit 82.

The predetermined number determination unit 82 confirms whether the number of recipient devices is larger than a first threshold, or whether the average response time is larger than a second threshold (S112). The first threshold and the second threshold are stored in advance in a memory or the like. If the predetermined number determination unit 82 confirms that the number of recipient devices is larger than the first threshold, or confirms that the average response time is larger than the second threshold (S112; YES), then the predetermined number determination unit 82 determines that the processing load of the mail server apparatus 1 is high. Having determined that the processing load of the mail server apparatus 1 is high, the predetermined number determination unit 82 decreases the predetermined number N (S113).

On the other hand, if the predetermined number determination unit 82 confirms that the number of recipient devices is equal to or less than the first threshold and that the average response time is equal to or less than the second threshold (S112; NO), then the predetermined number determination unit 82 further confirms whether the number of recipient devices is less than a third threshold and whether the average response time is less than a fourth threshold (S114). The third threshold and the fourth threshold are stored in advance in a memory or the like. If the predetermined number determination unit 82 confirms that the number of recipient devices is less than the third threshold, and that the average response time is less than the fourth threshold (S114; YES), then the predetermined number determination unit 82 determines that the processing load of the mail server apparatus 1 is low. Having determined that the processing load of the mail server apparatus 1 is low, the predetermined number determination unit 82 increases the predetermined number N (S115).

It is to be noted that if the number of recipient devices is equal to or less than the first threshold and the average response time is equal to or less than the second threshold (S112; NO), and further the number of recipient devices is equal to or larger than the third threshold or the average response time is equal to or larger than the fourth threshold, then the predetermined number determination unit 82 determines that the processing load is usual, and neither increase nor decrease the predetermined number N.

(Actions and Effects of Third Embodiment)

As described above, in the mail server apparatus 1 in the third embodiment, the predetermined number N serving as the upper limit value of the number of e-mails moved from the hold box 32 into the mail box 38 is updated in accordance with the processing load of the mail server apparatus 1. Specifically, as the processing load of the mail server apparatus 1 increases, the predetermined number N is decreased, whereas as the processing load decreases, the predetermined number N is increased.

Thus, in cases where the processing load of the mail server apparatus 1 is high, a larger number of e-mails than in the case of a usual processing load are treated as if they had not arrived yet, and in cases where the processing load of the mail server apparatus 1 is low, the number of e-mails treated as if they had not arrived is smaller than in the case where the processing load is usual.

Accordingly, according to the third embodiment, not only a temporary abrupt increase of the processing load of the mail server apparatus 1 may be suppressed, so that the mail server apparatus 1 is prevented from becoming congested, but also mail server apparatus 1 performs it's best because as many number of e-mails are processed as it can processes. Therefore, the processing capability of the mail server apparatus 1 may be used with good efficiency.

(Modification)

The SMTP server 20 and the POP server 21 may be implemented by one device as each of the above-described embodiments, and may also be implemented by separate devices.

As demonstrated in the above-described embodiments, the received e-mails are once stored in the provisional box 31 and then are moved into the hold box 32 for the purpose of exclusive control. About the exclusive control, the control to avoid the trouble that might occur when the other side started reading this while one side is writing the file in the folder, when SMTP server and POP server do the file delivery through the transmission or the reception folder. Therefore, if exclusive control of e-mails is possible, e-mails may be stored in the hold box 32 without being stored in the provisional box 31.

(Supplement)

Results obtained by verifying actions and effects of the above-described embodiments using an M/M/1 queuing model will be demonstrated below.

Assume that the total number of the recipient devices 9 is N, and the rate at which each recipient device 9 checks e-mails per unit time is r. Also, r may be considered as a time interval at which the device checks e-mails. In other words, it is considered that e-mail checking is performed (N×r) times, as a whole, for one minute. In the case where there is no waiting time, assume that it takes u seconds on average to perform e-mail checking one time. That is, u is response time of e-mail checking in the case of a single user, and is expressed as the sum of response time u0 of the mail server apparatus 1 in the case where there is no e-mail and processing time ul(m) that is roughly in proportion to the number m of e-mails (u=u0+ul(m)). Where ‘m’ is number of e-mails.

Further, assume that the mail server apparatus 1 has the capability of processing X requests for e-mail checking per unit time. If the mail server apparatus 1 processes only requests for e-mail checking, the following relationship roughly holds: (X=1/u).

Using an M/M/1 queuing model, the average time from a request for e-mail checking to receiving a response in the recipient device 9 (hereinafter referred to as “waiting time”) may be expressed by the following expression (Expression 1).

rNu/(X−rN) (Expression 1)

Here, assuming that the mail server apparatus 1 may process 2000 e-mails per minute, and it takes 0.5 second to perform other processing (such as account management) required for each e-mail checking process, the duration (response time) u (m) of e-mail checking is expressed by the following Expression 2.

u(m)(in seconds)=0.5+(the number of e-mails:m)×60/2000 (Expression 2)

As described above, the number X of e-mail checking per unit time is given by X=1/u(m).

Under such presumptions, assume an instance in which an abrupt increase in processing load temporarily appears in the mail server apparatus 1. Specifically, an instance in which 80% of 200 recipient devices 9 checks e-mails in 5 minutes after the commencement of work is assumed. The waiting time of e-mail checking, when estimated using the above-mentioned (Expression 1) and the like, is as expressed in Table 1 below. The “number of e-mails” in the below Table 1 is the number of e-mails per user that are received by the mail server apparatus 1 and is not presented to a user. The “number of checked e-mails” represents the above-described (N×r) in the case of N=160 (units) (=200×0.8) and r=1/5.

TABLE 1

| | | | Interval of | Number of | |
|---|---|---|---|---|---|
| | | X | E-Mail | Checked | Waiting |
| Number of | u (m) | (e-mails/ | Checking | E-Mails | Time |
| E-Mails | (sec) | min) | (min) | (e-mails/min) | (s) |
| 20 | 1.1 | 54 | 5 | 32 | 2.7 |
| 40 | 1.7 | 35 | 5 | 32 | 18.2 |
| 50 * | 2.0 | 30 | 5 | 32 | Congestion |

* ‘min’ stands for minutes.

Similarly, in an instance in which 80% of 200 recipient devices 9 checks e-mails in 4 minutes after the commencement of work, the waiting time of e-mail checking is as expressed in Table 2 below.

TABLE 2

| | | | Interval of | Number of | |
|---|---|---|---|---|---|
| | | X | E-Mail | Checked | Waiting |
| Number of | u (m) | (e-mails/ | Checking | E-Mails | Time |
| E-Mails | (s) | min) | (min) | (e-mails/min) | (s) |
| 10 | 0.8 | 75 | 4 | 40 | 1.7 |
| 20 | 1.1 | 54 | 4 | 40 | 4.1 |
| 30 | 1.7 | 42 | 4 | 40 | 21.0 |
| 40 * | 2.0 | 35 | 4 | 40 | Congestion |

In this manner, the number of e-mails that have been received by the mail server apparatus 1 and has not yet been sent to a user is larger than usual such that the majority of the recipient devices 9 intensively checks e-mails. It is found that the mail server apparatus 1 easily enters a congested state in such a situation. If the mail server apparatus 1 enters such a congested state, there is a possibility that the congested state may not disappear for more than one hour because there are a shortage of system resources, repeated requests from each recipient device 9, and the like.

However, among e-mails that have been received by the mail server apparatus 1 and have not yet been sent to a user, the number of e-mails to be assigned higher priority may be assumed to be not much different from that during normal times.

Accordingly, the mail server apparatus 1 according to the present embodiment selects only the predetermined number, N, of e-mails, as e-mails to be processed, from e-mails of high priority, and treats the other e-mails as if they had not arrived. Thus, the value of u (m) does not largely increase, and the processing capability X of the mail server apparatus 1 does not largely decrease. Even in instances of the above Table 1 and Table 2, if the predetermined number N indicating the upper limit of the number of e-mails to be processed is set to, for example, 20, the other e-mails are treated as if they had not arrived, and therefore it may be verified that a congested state does not occur.

Therefore, in cases where the mail server apparatus 1 according to the present embodiment is applied to an intra-company mail server for business use, if employees concurrently start checking e-mails after holiday weekend or the like as in the above-described instances, the following situation is predicted.

In four minutes after the commencement of work after holiday weekend or the like, 80% of 200 employees checks e-mails roughly concurrently. For the four minutes, the number of e-mails to be processed for each user is limited by using the predetermined number N, and therefore the processing load of the mail server apparatus 1 continues to remain in a somewhat high state even though the processing load does not enter a congested state. Thereafter, each employee reads a downloaded e-mail, and therefore the processing load of the mail server apparatus 1 gradually decreases.

When more time has elapsed, part of employees who have finished reading e-mails starts replying. Also, employees who have finished reading e-mails received at first check e-mails again. This e-mail checking may be supposed to be temporally scattered more than the e-mail checking immediately after the commencement of work.

In this second e-mail checking, as described above, e-mails treated as if they had not arrived yet and held in the hold box 32 are moved into the mail box 38, and are downloaded by each user. As such, the e-mails that have been treated as if they had not arrived are treated as new e-mails every time of e-mail checking, and therefore even e-mails that have been treated as if they had not arrived yet are necessarily delivered to a user.

Thus, according to the mail server apparatus 1 in the present embodiment, without enhancing the hardware capability of the device itself and without setting a limitation on operation for a user, a temporary abrupt increase in processing load of the mail server apparatus 1 may be suppressed, and thus the mail server apparatus 1 may be prevented from entering a congested state.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mail server apparatus comprising:
a receiving unit configured to receive a plurality of e-mails addressed to a user;
a determination unit configured to determine a priority of each of the e-mails received by the receiving unit; and
a processing unit configured to select a predetermined number of e-mails from the plurality of e-mails received by the receiving unit, on the basis of priority determined by the determination unit, and treat e-mails as if the e-mails had not arrived, except for the selected predetermined number of e-mails, upon receipt of a request from a user device.

2. The mail server apparatus according to claim 1,
wherein the processing unit processes an electronic mail that has been treated as if the electronic mail had not arrived, as a new electronic mail addressed to the user upon receipt again of a request from the user device.

3. The mail server apparatus according to claim 1, further comprising:
a first storage unit configured to store the plurality of e-mails received by the receiving unit; and
a second storage unit configured to store e-mails to be processed as delivered e-mails addressed to the user,
wherein the processing unit moves the selected predetermined number of e-mails from the first storage unit to the second storage unit, leaves in the first storage unit the e-mails to be treated as if the e-mails had not arrived, and sends a response message as a response to a request from the user device, on the basis of the e-mails stored in the second storage unit.

4. The mail server apparatus according to claim 1, further comprising:
an acquisition unit configured to acquire a processing load of the mail server apparatus; and
a change unit configured to change the predetermined number of e-mails in accordance with the processing load acquired by the acquisition unit.

5. The mail server apparatus according to claim 1,
wherein the processing unit adds information on e-mails treated as if the e-mails had not arrived to a response message as a response to the request from the user device.

6. An electronic mail processing method performed by a mail server apparatus, the method comprising:
receiving a plurality of e-mails addressed to a user;
determining a priority of each of the received e-mails;
based on the priority, selecting a predetermined number of e-mails from the received plurality of e-mails; and
treating e-mails as if the e-mails had not arrived, except for the selected predetermined number of e-mails, upon receipt of a request from a user device.

7. The electronic mail processing method according to claim 6, further comprising:
storing a first storage the received plurality of e-mails; and
storing a second storage e-mails to be processed as delivered e-mails addressed to the user,
wherein the selected predetermined number of e-mails are moved from the first storage to the second storage, the e-mails to be treated as if the e-mails had not arrived are left in the first storage, and, on the basis of the e-mails stored in the second storage, a response message as a response to a request from the user device is sent.

8. The electronic mail processing method according to claim 6, further comprising:
acquiring a processing load of the mail server apparatus; and
changing the predetermined number of e-mails in accordance with the acquired processing load.

9. A non-transitory computer-readable recording medium recorded with a program for electronic mail processing to be executed by a computer, the program for electronic mail processing causing the computer to execute a method, the method comprising:
receiving a plurality of e-mails addressed to a user;
determining a priority of each of the received e-mails;
based on the priority, selecting a predetermined number of e-mails from the received plurality of e-mails; and
treating e-mails as if the e-mails had not arrived, except for the selected predetermined number of e-mails, upon receipt of a request from a user device.

10. The non-transitory computer-readable recording medium according to claim 9,
wherein the method further comprises:
storing the received plurality of e-mails in a first storage unit; and
storing, in a second storage unit, e-mails to be processed as delivered e-mails addressed to the user, and
wherein the selected predetermined number of e-mails are moved from the first storage unit to the second storage unit, the e-mails to be treated as if the e-mails had not arrived are left in the first storage unit, and, on the basis of the e-mails stored in the second storage unit, a response message as a response to a request from the user device is sent.

11. The non-transitory computer-readable recording medium according to claim 9,
wherein the method further comprises:
acquiring a processing load of the mail server apparatus; and
changing the predetermined number of e-mails in accordance with the acquired processing load.
